(19) United States
(12) Patent Application Publication
(10) Pub. No.: US 2017/0349436 A1
(43) Pub. Date: Dec. 7, 2017

(54) METHOD OF CHLORINE DIOXIDE GENERATION IN HIGHLY ACIDIC ENVIRONMENTS

(71) Applicant: Carlos Alvarado, Fernandina Beach, FL (US)

(72) Inventor: Carlos Alvarado, Fernandina Beach, FL (US)

(21) Appl. No.: 15/616,487

(22) Filed: Jun. 7, 2017

Related U.S. Application Data
(60) Provisional application No. 62/346,961, filed on Jun. 7, 2016.

(51) Int. Cl. C01B 11/02

(52) U.S. Cl. CPC C01B 11/026; C01B 11/025

(57) ABSTRACT

A method for boosting the efficiency of chlorine dioxide production in a chemical facility. A chloride donor is introduced into a feed of sulfuric acid or a reducing agent, both of which are injected into the recirculation lines, or other areas, of a chlorine dioxide producing facility. The chloride donor provides the intermediate chemical species necessary for the efficient generation of chlorine dioxide at high acidities and/or the high local acidity in the wake zone of the acid injection location, thereby enabling greater efficiency in the reduction of chlorine dioxide from sodium chlorate.

### CROSS-REFERENCE TO RELATED APPLICATION

Pursuant to 35 U.S.C. §119(e), this application claims the benefit of U.S. Provisional Patent Application Ser. No. 62/346,961, filed on Jun. 7, 2016, the entire contents of which are incorporated herein by this reference.

### BACKGROUND

### (1) Field of Endeavor

The present disclosure relates generally to the field of efficiency optimization of chlorine dioxide generating facilities, and more particularly, to using a deliberate and targeted method of introducing a chloride donor compound into the acid and/or reducing agent feeds of the facility to boost efficiencies of the overall facility.

### (2) Description of Related Art

Many commercial chemical facilities generate chlorine dioxide (ClO₂) on a large scale. As one example, bleach plants in pulp mills almost exclusively use ClO₂ generators that reduce sodium chlorate with a reducing agent, such as methanol or hydrogen peroxide. The ClO₂ chemical reaction involves the reduction of sodium chlorate with the reducing agent in the presence of sulfuric acid to produce gaseous ClO₂ and other byproducts. A chloride ion (Cl—) is an intermediate species needed for the formation of chlorine dioxide in both methanol-type and hydrogen peroxide-type generating processes.

The ClO₂ generating process stops if acidities become too high. For example, at acidities above about 10 N, depending on the generator conditions, the chloride intermediate cycle in a methanol reaction will be stopped, and the reaction will produce chlorine gas. This is called a “Whiteout.” At this point, the production of ClO₂ ceases, chlorine is produced, and the chemical facility shuts down to stop the addition of chemicals, therefore resulting in the loss of production of the chemical facility. Whiteouts can be stopped by adding water to reduce high acidity concentrations. Another method of preventing Whiteouts is by adding a chloride donor in the chemical process to enable the continued generation of ClO₂ in highly acidic environments. Most modern ClO₂ plants use a diluted crystal sodium chlorate feed that is low in chlorides in order to minimize chlorine production. Some plants add sodium chloride in bulk in the chlorate feed to maintain a residual chloride content throughout the reaction volume to avoid Whiteouts and to run in the upper values of the acidity control range. The widespread chloride content in the reaction volume results in generator inefficiencies by the unwanted production of chlorine.

Inefficient mixing of acid creates localized boundaries of elevated acid concentration that result in a chlorine generating reaction, especially near the injection location. The partial creation of chlorine results in an efficiency loss in the chemical facility. The inefficient reduction of chlorate into chlorine occurs near the acid injection point where the acidity is highest.

Therefore, what is needed is a process by which a chloride donor is introduced into the generator or recirculation lines using a deliberate and targeted method that sustains the chloride intermediate cycle in high acidity zones, thereby boosting the overall efficiency of the chlorine dioxide producing chemical facility.

### SUMMARY

The method is directed to boosting the efficiency of chlorine dioxide production in a chemical facility. A chloride donor is introduced into a feed of sulfuric acid or a reducing agent using a deliberate and targeted method. Both of the acid feed and reducing agent feed are added into the recirculation lines or directly into the generator of a chlorine dioxide producing facility. The chloride donor provides the necessary chloride ion at high local acidity in the wake zone of the injection location, or when overall acidities reach high levels in the generator, thereby enabling greater efficiency in the reduction of chlorine dioxide from sodium chlorate.

### BRIEF DESCRIPTION OF THE DRAWINGS

FIG. 1 shows one embodiment of a large scale ClO₂ generator.

FIG. 2 shows a segment of a representative recirculation line where a representative injector for the acid feed or reducing agent feed introduces acid into the recirculation line.

FIG. 3 shows a diagram of turbulence created by a cylinder corresponding to different Reynolds numbers.

FIG. 4 shows one embodiment of a large scale ClO₂ generator having a ClO₂ feed drawn from a ClO₂ product line.

FIG. 5 shows a segment of a representative recirculation line where a representative injector for the acid feed or reducing agent feed and a representative chloride donor injector, where the chloride donor is introduced in the wake zone of the acid injector or the reducing agent injector.

FIG. 6 shows a side view and a top view of one embodiment of an acid injector.

FIG. 7 shows a side view of one embodiment of an acid injector or a reducing agent injector.

FIG. 8 shows a top view of one embodiment of an acid injector or a reducing agent injector.

### DESCRIPTION OF THE PREFERRED EMBODIMENT

With reference to the drawings, the process for chlorine dioxide generation in highly acidic environments will now be described with regard for the best mode and the preferred embodiment. In general, the process is directed to optimizing the efficiency of chlorine dioxide producing chemical facilities. The embodiments disclosed herein are meant for illustration and not limitation of the invention. An ordinary practitioner will appreciate that it is possible to create many variations of the following embodiments without undue experimentation.

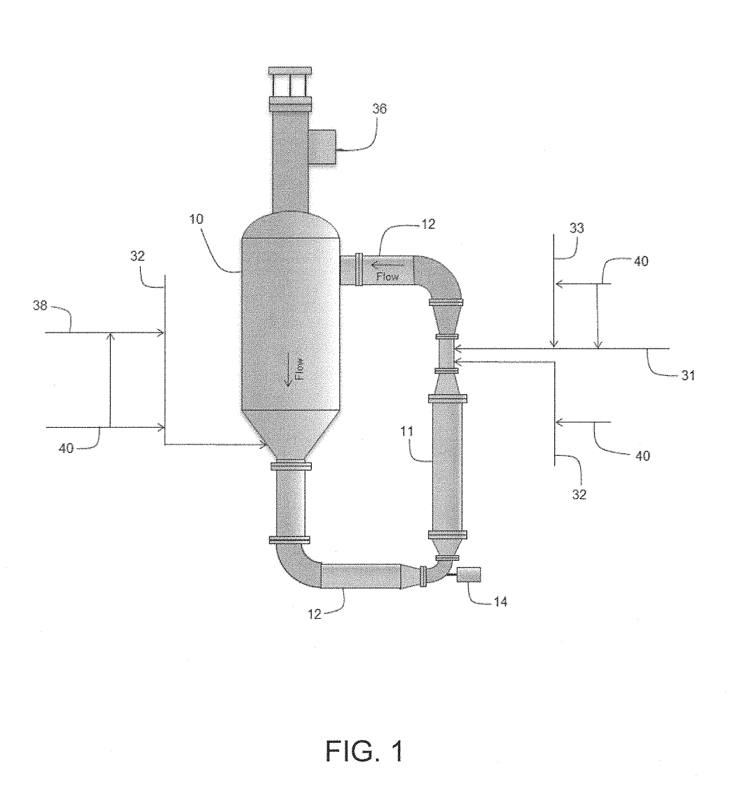

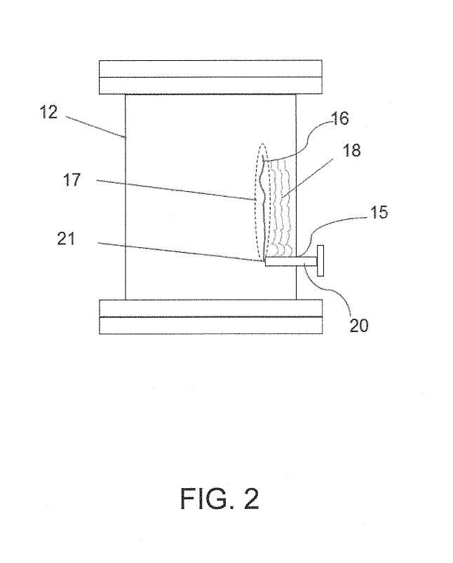

Referring to FIG. 1, an exemplary chlorine dioxide producing chemical facility comprises a chlorine dioxide generator 10, a reboiler 11, and one or more recirculation lines 12 that fluidly connect the generator 10 and the reboiler 11. Many such systems comprise a pump 14 for circulating fluid through the recirculation lines 12. Referring to FIG. 2, the recirculation lines 12 comprise one or more injection ports 15 configured to receive various injectors 20, such as one or more acid injectors 20 that introduces acid from one or more acid feeds 21 into the recirculation lines 12. The ports 15 can also be configured for receiving reducing agent injectors 20 for receiving a reducing agent from a reducing agent feed 32. In one embodiment, the injectors 20 emit a plume 16 from the tip 21, where the plume 16 develops a highly acidic zone 17. The highly acidic zone 17 occurs downstream from the injector 20 in or near the wake zone 18.

In general, there are many commercially available processes for the large-scale generation of chlorine dioxide (ClO₂). As one example, bleach plants in pulp mills almost exclusively use ClO₂ generators that reduce sodium chlorate with methanol or hydrogen peroxide. The ClO₂ chemical reaction involves the reduction of sodium chlorate with a reducing agent in the presence of acid, such as sulfuric acid, to produce gaseous ClO₂, a byproduct sulfate salt, some amounts chlorine, and other minor byproducts. While there are several acids that are suitable for ClO₂ production, the present discussion is presented in terms of the exemplary acid of sulfuric acid. There are many forms of writing equations for this reaction. The following are two representative examples of this reaction with methanol acting as the reducing agent:

6NaClO₃+CH₃OH+4H₂SO₄→6ClO₂+CO₂+5H₂O+2Na₃H(SO₄)₂

or

6NaClO₃+1.5CH₃OH+4H₂SO₄→6ClO₂+1.5HCOOH+4.5H₂O+2Na₃H(SO₄)₂

Chlorine dioxide can also be produced by reducing sodium chlorate with hydrogen peroxide in a manner similar to that shown above. An example of one such reaction is:

NaClO₃+0.5H₂O₂+0.5H₂SO₄→ClO₂+H₂O+0.5O₂+0.5Na₂SO₄

The hydrogen peroxide reaction may be carried out in different acid concentrations producing neutral sodium sulfate or acidic sodium sesquisulfate byproduct salt.

### Chloride Intermediate Reactions

A chloride ion (CF) is an intermediate species needed for the formation of chlorine dioxide in the ClO₂ generating process, whether the reducing agent is methanol or hydrogen peroxide.

### Methanol Chemistry

The following reaction equations show an example of the chloride ion intermediate cycle represented by HCl sustained in the methanol-based process. The HCl intermediate is produced and consumed as the reaction proceeds:

HClO₃+HCl→HClO₂+HClO Reaction (1)

HClO₃+HClO₂→2ClO₂+H₂O Reaction (2)

HClO+CH₃OH→HCl+HCHO+H₂O Reaction (3)

At high acidities the following reaction, which produces chlorine, becomes an inefficient reaction:

HClO+HCl→Cl₂+H₂O(High acidity reaction) Reaction (4)

### Peroxide Chemistry

The following equations show an example of the chloride ion intermediate cycle in the hydrogen peroxide based process:

2ClO₃⁻+2+4H⁺→2ClO₂+Cl₂+2H₂O Reaction (5)

Cl₂+H₂O₂→2Cl⁻O₂+2H⁺ Reaction (6)

This overall reaction can be summarized as:

2ClO₃⁻+H₂O₂+2H⁺→2ClO₂+2H₂O+O₂ Reaction (7)

### Whiteouts

At acidities typically above about 10 N, depending on generator conditions, the chloride intermediate cycle in Reactions (1), (2) and (3) will be stopped, and the reaction will produce chlorine gas (Reaction (4)). This phenomenon is known in the industry as a “Whiteout.” The production of ClO₂ ceases, chlorine is produced, and the chemical facility interlocks, or shuts down, to stop the addition of chemicals, therefore resulting in the loss of production of the chemical facility. Whiteouts can be stopped by adding water to reduce acidity or by adding chloride—the required intermediate—to generate ClO₂. During normal operations, the localized high acidities adjacent to the acid feed 31 injection point can drive part of the production of chlorine via Reaction (4), generating chlorine alongside chlorine dioxide, thereby decreasing the efficiency of the plant.

### Stoichiometric Consumption and Efficiency of Sodium Chlorate

The stoichiometric consumption of sodium chlorate required to produce chlorine dioxide is about 1.58 T NaClO₃/T ClO₂. In general, chlorine dioxide-producing chemical facilities have chlorate consumptions typically from about 1.64 to about 1.8 NaClO₃/T ClO₂ or lower. These correspond to efficiencies between about 96% and 87% and lower, respectively. There are many non-chemical operational factors that contribute to inefficiencies in ClO₂ producing chemical facilities, such as equipment inefficiencies, measurement inaccuracies, contaminants, human error, and other similar factors. However, even during the rigors of performance tests in new chemical facilities when the equipment is in optimal condition, efficiencies close to or above about 96% are not encountered.

### Chemical Feed Addition in a ClO₂—Producing Chemical Facility

In one embodiment, an acid, such as sulfuric acid, is introduced into a chlorine dioxide producing chemical facility near the outlet of the reboiler 11 into a recirculating generator solution stream several orders of magnitude larger than the flow of the acid itself. For instance, in an 80 tons per day (tpd) ClO₂ chemical facility, the flow of acid mixed with dilution water is about 11 gallons per minute (gpm). This is introduced into generator solution stream with flow of about 12,000 gpm flowing at about 12 ft/sec. The acid is introduced through one or more acid injectors 20 that typically protrude some distance inside the inner wall of the recirculation line 12 (See FIG. 2). The pipe for the recirculation line 12 increases in diameter progressively downstream from the acid injection point at the injection port 15. The pipe is designed to promote acid mixing by the Venturi effect. Residence time of acid in this recirculation pipe is brief, typically only a about few seconds. Conversion reaction of sodium chlorate to ClO₂ or Cl₂ occurs at a relatively rapid rate. Therefore, most of the ClO₂ generating reaction is complete before the reactants leave the recirculation line 12 and enter into the generator 10.

### Mixing Inside Recirculation Lines

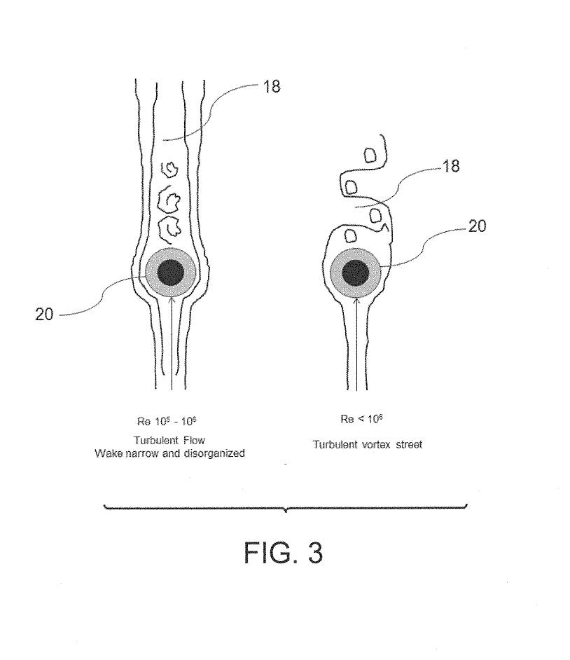

Flow in the recirculation lines 12 is turbulent at Reynolds numbers of about 10⁵ to about 10⁶. At these Reynolds numbers, the wake zone 18 is very narrow and disorganized, as shown in FIG. 3. Feeding the acid into the recirculation line 12 at these Reynolds numbers creates zones of high acidities, as shown in FIGS. 2 and 3. The rapid nature of the reaction allows Reaction (4) to proceed in the high acidity zones after the acid is injected into the recirculation lines 12.

ClO₂-producing chemical facilities typically must dilute the acid feed 31 with water, which is referred to as acid dilution water, through a dilution water feed 33. This water is added to reduce the acid heat of dilution and to promote mixing prior to entering the reaction stream. The sulfuric acid concentration mostly used in ClO₂ producing chemical facilities is about 92%. The acid is diluted with dilution water to a solution that ranges from about 60 weight percent (wt %) to about 70 wt % prior to entering the recirculation line 12. After acid dilution, the resulting acid concentrations added to the recirculation line 12 are about 14 N to about 22 N. The acid feed 31 concentration is therefore well above the concentration threshold for favoring localized chlorine production according to Reaction (4). FIG. 3 shows flow patterns through a cylindrical body, such as a pipe, for acid injectors 20 and different Reynolds numbers typically encountered in the pipes of the recirculation lines 12.

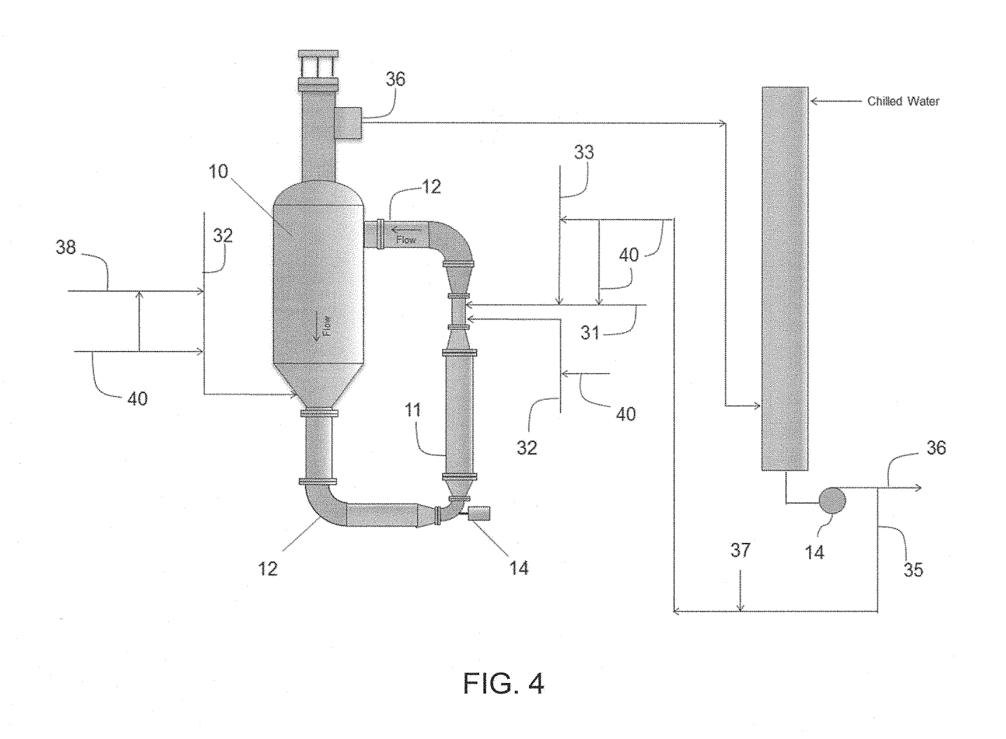

Referring to FIG. 4, one embodiment of an acid injector 20 that introduces the diluted acid feed 31 from the tip 21 of the injector 20. The acid introduced remains in the tip 21 vortex wake zone 18 near the injection point, as shown in FIG. 2.

Since the reduction of sodium chlorate into ClO₂ occurs very rapidly, a significant portion of the reaction occurs while the acid plume 16 is still in the vortex wake zone 18 of the tip 21. This results in a localized highly acidic zone 17 where the chloride intermediate is depleted, resulting in the production of some chlorine via Reaction (4) and in decreased efficiency of the overall chemical facility.

If the flow of acid dilution water stops while ClO₂ is being generated, a plant shutdown typically follows. The shutdown is triggered ultimately by an increase in generator gas pressure due to an increase in the amount of gases inside the generator. This increase in gases can be the result of a gaseous ClO₂ decomposition, which produces chlorine gas and oxygen and/or an increase in chlorine generation via Reaction (4) in the extremely high acidity regions created after feeding undiluted acid. Thus, stopping the flow of dilution water and its subsequent result can be due to inefficient acid mixing.

### Loss of Efficiency Due to Poor Mixing:

Referring to an embodiment where the acid is sulfuric acid, inefficient mixing of the sulfuric acid creates localized boundaries of elevated acid concentration in a highly acidic zone 17 (see FIG. 2) that favor Reaction (4) above. The partial creation of chlorine results in efficiency loss in the chemical facility. The inefficient reduction of chlorate into chlorine occurs near the sulfuric acid injection point where the acidity is highest. The conversion to ClO₂ instead of chlorine improves as the reactants travel through the circulation line with increased mixing and reduction of localized high acidity. The same inefficient reaction can occur at any place in the generating system when chlorate is reacted with a reducing agent at high acidities. The addition of a chloride ion donor in the reducing agent will enhance efficiency wherever chlorate reduction takes place in a highly acidic zone. As an added benefit, addition of a chloride donor enables continuous operation of the generator 10 at the higher acidity concentrations in the system, thus increasing the overall efficiency of ClO₂ generation in the system.

Efficiency Increase by Adding Chloride Donor in Acid Feed and/or Reducing Agent Feed

In order to increase or maintain the efficiency of ClO₂ production in the chemical facility, the chloride intermediate cycle shown in example Reactions (1), (2), and (3) must be sustained or enhanced in high acidity zones. To avoid Reaction (4) from occurring, a chloride donor is added via a chloride donor feed 40. The chloride donor could be one of a number of chemicals or compounds, such as alkali metal chlorides (sodium chloride, potassium chloride, lithium chloride, and the like), hydrochloric acid, sodium hypochlorite, thionyl chloride, sulfuryl chloride, phosphate-chloride compounds (phosphorous trichloride and phosphorous pentachloride), sodium chlorite, other suitable organic or inorganic chloride donors, chloride donor promoters (compounds that yield chlorides) or combinations thereof. For example, introduction of the chloride donor feed 40 into the acid feed 31 or reducing agent feed 32 avoids Reaction (4), thereby avoiding the inefficient production of chlorine gas.

Sodium chlorite is in the chloride donor promoter category, and it is of special interest. Sodium chlorite can react with the inefficient Reaction (4) as follows:

HClO+HCl→Cl₂+H₂O(High acidity reaction) Reaction (4)

2NaClO₂+HClO+HCl→2ClO₂+H₂O+2NaCl Reaction (8)

or

2NaClO₂+Cl₂→2ClO₂+2NaCl Reaction (9)

In this case sodium chlorite prevents the formation of chlorine through Reaction (8), or it reacts with chlorine generated from Reaction (4) to generate ClO₂ through Reaction (9). Under either Reaction (8) or (9), the sodium chlorite provides NaCl, which is a chloride donor for Reactions (1), (2) and (3). Sodium chlorite can be manufactured in the ClO₂ facility by reacting ClO₂ with NaOH or other suitable reactants, such as hydrogen peroxide, or combination thereof, and returned to be added into the ClO₂ generating process at the desired feed locations. For example, in one embodiment, shown in FIG. 4, a ClO₂ feed 35 is drawn from a ClO₂ product line 36. The ClO₂ feed 35 is circulated back for introduction into the recirculation lines 12. A NaOH feed 37 is introduced into the ClO₂ feed 35, and the solution is mixed to form a quantity of sodium chlorite in situ. The sodium chlorite then acts as the chloride donor compound for the chloride donor feed 40. Sodium chlorite can also be used throughout the chlorine dioxide generating system to mitigate the production and occurrence of chlorine.

Referring again to FIG. 1, the chloride donor is introduced into the system via a chloride donor feed 40, which is preferably located upstream from the chlorine dioxide generator 10. In one embodiment, the upstream introduction of the chloride donor is accomplished by introducing the chloride donor feed 40 directly into the acid feed 31 prior to the acid being injected into the recirculation lines 12. The selection of the addition points into the acid depends on the nature and compatibility of the chloride donor selected. In another embodiment, the upstream introduction of the chloride donor is accomplished by introducing the chloride donor feed 40 directly into the dilution water feed 33 prior to the acid being injected into the recirculation lines 12. Alternately, the chloride donor could be added directly to the dilution water or the acid prior to the dilution water or acid being introduced into their respective feeds 33, 31. These methods enable the necessary chloride intermediates to be located inside the high acidity zones that occur in the wake zone 18 of the acid injection location where chloride intermediates are depleted. In this way, chloride ions are available as intermediate species to produce ClO₂ through Reactions (1), (2) and (3), even when localized acidities are high.

Some ClO₂ chemical facilities feed methanol at locations downstream or upstream of the acid injectors 20 in the recirculation line 12. Methanol is typically diluted with water or the sodium chlorate feed 38 prior to entering the recirculation line 12. Similar to the method of introduction into the acid feed 31 described above, chloride donors can be added to the methanol feed, methanol dilution water, or the sodium chlorate feed 38 at concentrations that promote Reactions (1), (2), and (3) above. Particularly for chemical facilities that feed methanol at a location downstream of the acid injection location, residual chloride donors enhance efficiency. Chlorides can also be added to hydrogen peroxide systems in a similar manner to favor the production of ClO₂, as shown in equation (5) above. Alternately, the chloride donor can be added directly to the methanol, methanol dilution water, or the sodium chlorate prior to their respective introduction into their respective feeds.

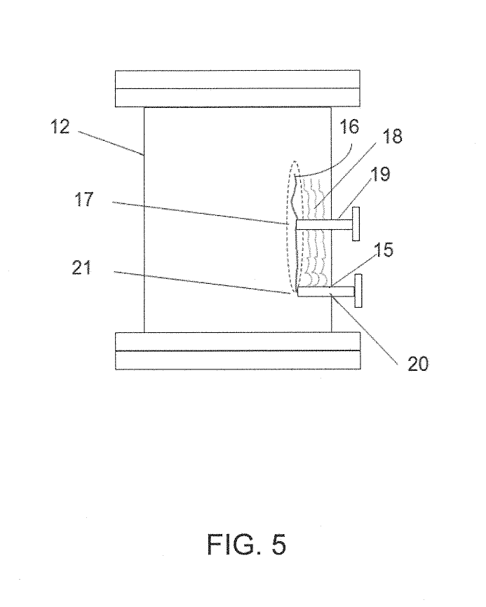

Referring to FIG. 5, in one embodiment, the chloride donor is introduced in separate chloride donor feed 40 via an chloride donor injector 19 located in the wake zone 18 of one of the injectors 20 from the acid feed 31, the reducing agent feed 32, or the sodium chlorate feed 38. It is preferred, but not required, that the chloride donor injector 19 is located in the wake zone 18 of the acid feed 31.

With the addition of chlorides as described above, stable production of ClO₂ is possible at higher generator acidity ranges than are normally encountered in the industry. As a result, ClO₂ chemical facilities are able to operate more efficiently at higher acid concentrations, and the Whiteouts risks are lowered because of the constant chloride feed in the correct high acidity zones when needed. Similarly, in one embodiment, the chloride donor is added through a chloride donor injector 19 located in the wake zone 18 of the injector 20 of the reducing agent feed 32.

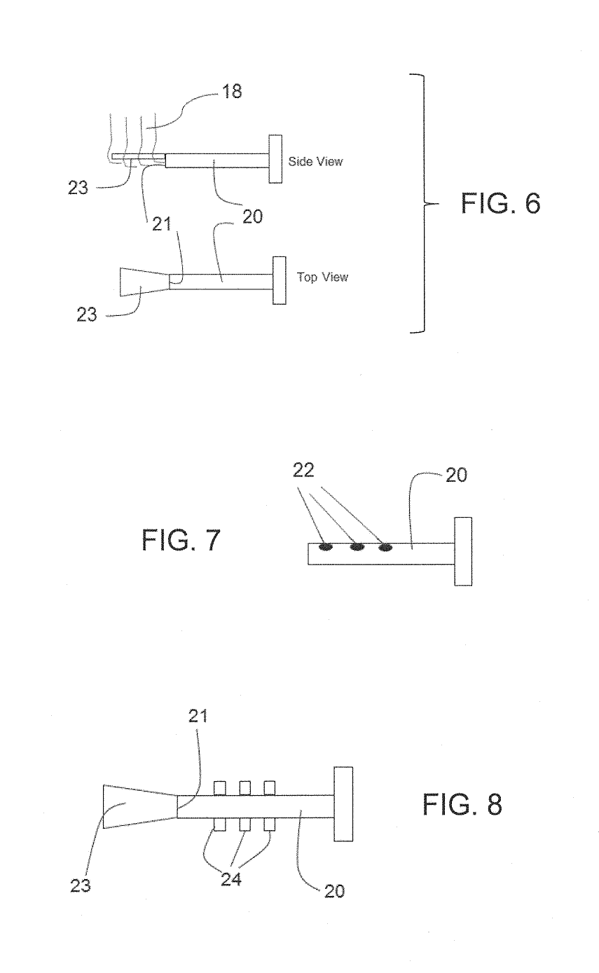

Referring to FIGS. 6-8, the shape of the injectors 20, and specifically the injectors 20 for the sulfuric acid, can aid in the mixing of the acid and/or reducing agent. Injectors 20 with other than cylindrical shapes can contribute to acid mixing. The acid injection orifices 22 (FIG. 7) and their orientation can contribute to the mixing of acid, thereby increasing ClO₂ chemical facility efficiency. In one embodiment, shown in FIG. 6, the injector 20 comprises a mixing plate 23 connected to the tip 21 of the injector 20. The mixing plate 23 is oriented substantially perpendicular to the flow through the recirculation line 12 such that the mixing plate 23 increases turbulence in the wake zone 18 of the injector 20. The increased turbulence causes an increase in the mixing action of the acid with the flow in the recirculation line 12.

Referring to FIG. 7, another embodiment of the injectors 20 comprises one or more orifices 22 through which the sulfuric acid is introduced into the recirculation line 12. This embodiment preferably comprises more than one orifice 22. The plurality of orifices 22 disperses the acid over a larger space inside the recirculation line 12, thereby promoting an enhanced mixing effect. In another embodiment, shown in FIG. 8, the injector 20 further comprises one or more fins 24. These fins 24 are oriented substantially perpendicular to the direction of flow inside the recirculation line 12, and they promote mixing in a manner similar to that of the mixing plate 23.

### Other ClO₂ Systems

Chloride donor addition to improve efficiency can be used in all ClO₂ producing systems, regardless of the size or complexity of the system. The feed of chloride intermediate into the acid and/or reducing agent is cascaded to the flow of the acid and/or reducing agent. In one embodiment of the method, the shutdown of the chloride donor feed is programed with the existing interlocks of the chlorine dioxide chemical facility. Compatible equipment and materials capable of resisting the corrosive environment are used throughout the system.

The foregoing embodiments are merely representative of the method for boosting the efficiency of chlorine dioxide production and not meant for limitation of the invention. For example, persons skilled in the art would readily appreciate that there are several embodiments and configurations of acid feeds, injectors, and recirculation lines that will not substantially alter the nature of the method. Consequently, it is understood that equivalents and substitutions for certain elements and components set forth above are part of the invention described herein.

The foregoing embodiments are merely representative of the method for chlorine dioxide generation and not meant for limitation of the invention. For example, persons skilled in the art would readily appreciate that there are several embodiments and configurations of acid feeds, injectors, and recirculation lines that will not substantially alter the nature of the method. Likewise, elements and features of the disclosed embodiments could be substituted or interchanged with elements and features of other embodiments, as will be appreciated by an ordinary practitioner. Consequently, it is understood that equivalents and substitutions for certain elements, components, and steps set forth above are part of the invention described herein, and the true scope of the invention is set forth in the claims below.

I claim:

1. A process for continuously producing chlorine dioxide, the process comprising the steps of:
introducing sodium chlorate into a system comprising a chlorine dioxide generator and a reboiler fluidly connected to the generator by one or more recirculation lines;
introducing a reducing agent into the system via a reducing agent feed in fluid communication with the one or more recirculation lines, the reducing agent selected from the group consisting of methanol and hydrogen peroxide;
introducing sulfuric acid into the system via an acid feed having an injector disposed in the one or more recirculation lines; and
introducing a chloride donor into the system via a chloride donor feed at a location upstream from the chlorine dioxide generator, the chloride donor selected from the group consisting of sodium chloride, potassium chloride, hydrochloric acid, sodium hypochlorite, thionyl chloride, phosphorous trichloride, phosphorous pentachloride, sodium chlorite, and sulfuryl chloride.

2. The method of claim 1, further comprising the step of introducing the chloride donor feed into the acid feed.

3. The method of claim 1, further comprising the steps of:
introducing acid dilution water into the acid feed via a dilution water feed; and
introducing the chloride donor feed into an acid dilution water feed.

4. The method of claim 1, further comprising the step of introducing the chloride donor into the sulfuric acid prior to the sulfuric acid being introduced into the acid feed.

5. The method of claim 1, further comprising the steps of:
introducing acid dilution water into the acid feed via a dilution water feed; and
introducing the chloride donor into the dilution water prior to the dilution water being introduced into the dilution water feed.

6. The method of claim 1, further comprising the steps of:
introducing the chloride donor feed into a recirculation line via a chloride donor injector; and
locating the chloride donor injector in a wake zone of the injector for the acid feed.

7. The method of claim 1, further comprising the step of introducing the chloride donor feed into the reducing agent feed.

8. The method of claim 1, further comprising the step of introducing the chloride donor into the reducing agent prior to introduction of the reducing agent into the reducing agent feed.

9. The method of claim 1, further comprising the step of introducing the chloride donor feed into the sodium chlorate feed.

10. The method of claim 1, further comprising the step of introducing the chloride donor into the sodium chlorate prior to introduction of the sodium chlorate into the sodium chlorate feed.

11. A process for continuously producing chlorine dioxide, the process comprising the steps of:
introducing sodium chlorate into a system comprising a chlorine dioxide generator, a reboiler fluidly connected to the generator by one or more recirculation lines, and a chlorine dioxide product line;
introducing a reducing agent into the system via a reducing agent feed in fluid communication with the one or more recirculation lines, the reducing agent selected from the group consisting of methanol and hydrogen peroxide;
introducing sulfuric acid into the system via an acid feed having an injector disposed in the one or more recirculation lines;
drawing a chlorine dioxide feed from the chlorine dioxide product line;
introducing a sodium hydroxide feed into the chlorine dioxide feed to produce sodium chlorite; and
introducing the sodium chlorite into the system via a chloride donor feed at a location upstream from the chlorine dioxide generator.

12. The method of claim 11, further comprising the step of introducing the chloride donor feed into the acid feed.

13. The method of claim 11, further comprising the steps of:
introducing acid dilution water into the acid feed via a dilution water feed; and
introducing the chloride donor feed into an acid dilution water feed.

14. The method of claim 11, further comprising the step of introducing the sodium chlorite into the sulfuric acid prior to the sulfuric acid being introduced into the acid feed.

15. The method of claim 11, further comprising the steps of:
introducing acid dilution water into the acid feed via a dilution water feed; and
introducing the sodium chlorite into the dilution water prior to the dilution water being introduced into the dilution water feed.

16. The method of claim 11, further comprising the steps of:
introducing the chloride donor feed into a recirculation line via a chloride donor injector; and
locating the chloride donor injector in a wake zone of the injector for the acid feed.

17. The method of claim 11, further comprising the step of introducing the chloride donor feed into the reducing agent feed.

18. The method of claim 11, further comprising the step of introducing the sodium chlorite into the reducing agent prior to introduction of the reducing agent into the reducing agent feed.

19. The method of claim 11, further comprising the step of introducing the chloride donor feed into the sodium chlorate feed.

20. The method of claim 11, further comprising the step of introducing the chloride donor into the sodium chlorate prior to introduction of the sodium chlorate into the sodium chlorate feed.
